(19) United States
(12) Patent Application Publication
(10) Pub. No.: US 2013/0247334 A1
(43) Pub. Date: Sep. 26, 2013

(54) Crucible for Solidifying a Silicon Ingot

(71) Applicants: Charles Huguet, Paris (FR); Emmanuel Flahaut, Puygros (FR); Hélène Lignier, Saint Laurent Du Pont (FR)

(72) Inventors: Charles Huguet, Paris (FR); Emmanuel Flahaut, Puygros (FR); Hélène Lignier, Saint Laurent Du Pont (FR)

(73) Assignee: COMMISSARIAT A L'ENERGIE ATOMIQUE ET AUX ENERGIES ALTERNATIVES, Paris (FR)

(21) Appl. No.: 13/819,655

(22) PCT Filed: Aug. 26, 2011
(86) PCT No.: PCT/IB2011/053748

§ 371 Date: Jun. 14, 2013

(30) Foreign Application Priority Data
Aug. 27, 2010 (FR) 1056804

(51) Int. Cl. B01D 9/00

(52) U.S. Cl. CPC B01D 9/00
USPC 23/295 R; 422/245.1; 427/230

(57) ABSTRACT

The present invention relates to a crucible that can be used for solidifying a silicon ingot from molten silicon, characterized in that same is at least partially coated on the inner surface thereof with at least one layer consisting of a material produced by thermal decomposition of polysilizane(s), said layer having a shear strength greater than 1 Pa and no higher than 500 MPa, and being in the form of a stack of adjoining layers of non-contiguous tiles. The invention also relates to a method for preparing such crucibles.

The present invention relates to a crucible of use for solidifying a silicon ingot from molten silicon.

It also relates to a process for preparing such a crucible and also to the use of such a crucible for treating molten silicon.

The crucibles according to the invention can especially be used in processes for melting and solidifying silicon, for the purpose, for example, of obtaining high-purity silicon for applications in the generation of photovoltaic energy.

Photovoltaic cells are, for the most part, made from monocrystalline or polycrystalline silicon, obtained from the solidification of liquid silicon in crucibles. It is the wafers cut from the ingot formed within the crucible that are used as the basis for the manufacture of the cells.

The crucibles considered for the growth of the ingot are generally silica crucibles, coated with a layer of oxidized silicon nitride to prevent the ingot adhering to the crucible after solidification.

More specifically, this non-stick behavior is based, for the most part, on the presence of silicon nitride, Si₃N₄, in the form of oxidized powders, at the surface of the inner walls of the crucibles to which the silicon adheres while it cools. While cooling, the silicon ingot detaches from these walls by cohesive failure within the silicon nitride layer, thus relaxing the mechanical stresses resulting from the difference in the thermal expansion coefficients.

However, this technique does not make it possible to prevent contamination of the silicon by the impurities present in the silicon nitride powder. For obvious reasons, this contamination, capable of existing at the zones of the silicon ingot formed in direct contact with or nearby the walls of the crucible, renders the ingot partly unsuitable for use in photovoltaic applications.

Therefore to date there remains a need for solidification crucibles that make it possible to easily detach the silicon ingot after it has cooled, while limiting the contamination of this ingot by the non-stick coating.

There also remains a need for such solidification crucibles that are, in addition, reusable.

The present invention specifically aims to propose novel crucibles, of use for solidifying a silicon ingot from molten silicon, which meet these needs.

The inventors have, indeed, discovered that these problems can be solved by forming, at the surface of the inner walls of a conventional crucible, a polysilazane-based coating constituted of a stack of non-touching tiles, having a particular shear strength.

A silicon ingot formed in contact with this stack detaches therefrom, for the most part, by cohesive failure within said stack.

Polysilazane has already been used as a material for reinforcing the oxidation resistance of certain carbon-based substrates. However, the processes proposed for its implementation consist of the formation, on the surface of the material to be treated, of a monolayer deriving from the thermal decomposition, by pyrolysis, of the previously deposited polysilazane (EP 0 411 611 and Journal of the European Ceramic Society, 16 (1996), 1115-1120).

However, the specific structure obtained within the context of the invention, namely a layer organized in the form of a superposition of several strata, each strata being formed of non-touching and non-superposed tiles, is not achieved therein.

Thus, the present invention relates, according to a first of its aspects, to a crucible of use for solidifying a silicon ingot from molten silicon, characterized in that it is coated at least partially on its inner surface with at least one layer formed from a material obtained by thermal decomposition of polysilazane(s), said layer having a shear strength greater than 1 Pa and less than or equal to 500 MPa, and being in the form of a stack of contiguous strata of non-touching tiles.

More particularly, said layer has a stratified structure, each stratum being formed of non-touching and non-superposed tiles.

Thus, the layer deriving from the thermal decomposition of polysilazane has a stratified architecture, in view of the fact that it is formed of at least two, or even several superposed strata that are positioned parallel to the treated inner surface of said crucible, each stratum being formed of non-touching tiles.

It is in view of this superposition of strata and of the particular structure of each stratum formed of an assembly of non-touching and non-superposed tiles, that the layer considered according to the invention has the appearance of a stack of tiles.

For the purposes of simplification, a layer in accordance with the invention could also be denoted in the text as being “a stack of strata”, each stratum being formed of non-touching tiles, or more simply “a stack of tiles” or else “a stack”.

According to one embodiment, the stack in accordance with the invention may comprise from 2 to 100 strata of tiles, said strata being superposed and contiguous.

Within the meaning of the invention, the term “contiguous” signifies that the strata in question are placed side by side and adjoining

Advantageously, the presence of more than three strata of contiguous tiles within the stack according to the invention makes it possible to obtain a crucible which is reusable as is, i.e. without having to implement prior treatment steps before reuse.

Such a stratified structure also makes it possible to distribute more uniformly the stress developed in the multiple interfaces during, in particular, the cooling of the silicon ingot.

Polysilazanes are organosilicon polymers, the main backbone of which consists of a sequence of silicon and nitrogen atoms.

These polymers are already proposed as pro-ceramic materials in view of their ability to form, by thermal decomposition, a ceramic material composed mainly of silicon, carbon and nitrogen atoms.

Such compounds are especially already used for the purposes of forming at the surface of various substrates, such as for example those made of graphite or of silica, a coating endowed with antioxidant and impermeability properties.

Quite unexpectedly, the inventors observed that polymers of this type prove particularly advantageous for attaining a layer that is in the form of a stack of non-touching tiles capable, on the one hand, of demonstrating non-stick properties with regard to solid silicon and, on the other hand, of guaranteeing an increased level of purity for the corresponding silicon ingot.

As it emerges from the exemplary embodiments that appear below, the crucibles according to the invention allow an easy detachment of the solidified silicon ingots, while significantly reducing the pollution thereof by the non-stick coating.

They can also be reused a large number of times without impairing their properties and prove, in this respect, particularly advantageous at an industrial level.

The non-stick properties of the crucibles according to the invention are especially obtained via the presence of the oxidized porous layer, the deoxidation kinetics of which are slow enough to prevent the infiltration of the liquid silicon in the layer up to contact with the substrate, and therefore to enable its detachment from the substrate.

The service life of the crucibles according to the invention will depend in particular on the number of strata of contiguous tiles present in the stack, and will be higher when this number is large.

According to another of its aspects, the present invention aims to propose a process for preparing a crucible as defined previously, comprising at least the formation of said layer via (a) the formation of a first stratum of tiles by (i) bringing the inner surface of said crucible into contact with a solution comprising at least one polysilazane, (ii) condensation-crosslinking of said polysilazane, (iii) pyrolysis under a controlled atmosphere and a controlled temperature and, optionally, (iv) oxidation annealing, followed by (b) the formation of at least one new stratum of tiles, contiguous to the stratum formed in step (a), by reproducing steps (i) to (iii) and, optionally, (iv), said process being characterized in that the pyrolysis of step (iii) of said process is carried out at a temperature hold realized at a temperature of at least 1000° C. for at least 1 hour.

For obvious reasons, the total number of strata in the stack in accordance with the invention will depend on the number of repetitions of step (b) indicated previously. This number of strata could thus be adjusted in view of the desired thickness of the stack and the desired properties.

The present invention also relates, according to another of its aspects, to the use of a crucible as defined previously, for directional solidification of silicon.

As indicated previously, the crucibles according to the invention are coated at least partially on their inner surface with at least one layer formed from a material obtained by thermal decomposition of polysilazane(s), with said layer being in the form of a stack of non-touching tiles, and having a particular shear strength.

Within the meaning of the invention, the expression “inner surface” is understood to denote the outer surface of the walls defining the internal volume of the crucible. The “internal volume of the crucible” denotes, within the meaning of the invention, the volume defined by the bottom surface and the side walls of the base body of the crucible.

The material forming the layer in accordance with the invention derives from the thermal decomposition of polysilazane(s).

The polysilazanes suitable for the invention may be represented by the following formula —(SiR′R″—NR′″)ₙ—(SiR*R**—NR***)ₚ—, in which R′, R″, R′″, R*, R** and R*** represent, independently of one another, a hydrogen atom or a substituted or unsubstituted alkyl, aryl, vinyl or (trialkoxysilyl)alkyl radical, n and p having values such that the polysilazane has an average molecular weight ranging from 150 to 150 000 g/mol.

Such polysilazanes are especially described in document US 2009/0286086.

The material forming the layer in accordance with the invention may be based on silicon carbide SiC, silicon nitride Si₃N₄ and/or silicon oxycarbonitride.

Silicon oxycarbonitride is understood to denote compounds of general formula SiₓO_{y}N_{z}C_{w}, such as for example those described in U.S. Pat. No. 5,438,025, such as for example SiNCO₂ or Si N_{0.52}O_{1.45}C_{0.32}.

More particularly, the material forming the layer in accordance with the invention derives from a heat treatment, of pyrolysis type, of a polysilazane.

Via the adjustment of the pyrolysis conditions, in terms of temperature hold, temperature rate and temperature maintenance and/or nature of the atmosphere considered during the pyrolysis, for example argon or nitrogen, it proves possible, on the one hand, to attain materials of particular composition for a given stratum and therefore to produce a stack of strata of tiles of identical or different chemical nature and, on the other hand, to modulate the structural organization of each of the strata.

It is precisely through this modulation in terms of composition and/or structural organization of the material forming each stratum of tiles that it proves possible to arrive at the required properties, in terms of shear strength of the layer in accordance with the invention.

It should be noted that the adjustment of the pyrolysis conditions in terms of temperature rate, more precisely in terms of heating rate, has no influence on the loss of mass and consequently on the shrinkage of the layer and on the formation of the tiles.

The tiles of the stack in accordance with the invention may be made of silicon carbide SiC, silicon nitride Si₃N₄, a mixture of SiC and Si₃N₄, or even silicon oxycarbonitride SiCNO.

According to one embodiment, the tiles forming all of the strata constituting said layer may be made of one and the same material.

According to another embodiment, the tiles forming all of the strata constituting said layer may be constituted of two different materials. In this second embodiment, the tiles may have different compositions from one stratum to another, in view, for example, of different conditions used for forming each of the corresponding strata.

The stack of the strata of non-touching tiles may be produced using any technique known to a person skilled in the art, and especially by chemical vapor deposition (CVD) or by dip coating, and more particularly those techniques described in the publication by Bill et al. (J. of the European Ceramic Soc., vol. 16, 1996: 1115).

The morphological characteristics of the tiles obtained according to the invention will also depend of course on the conditions of their formation, and in particular on the nature of the deposition solution and also on the parameters used for the heat treatment and in particular on the temperature.

Generally, the thickness of each of the strata of tiles forming the stack in accordance with the invention may be between 0.2 and 50 μm, in particular between 1 and 50 μm, for example between 0.5 and 20 μm, for example between 1 and 5 μm.

As regards the thickness of the stack in accordance with the invention, it may be between 10 and 500 μm, in particular between 20 and 500 μm, for example between 30 and 400 μm, preferably between 50 and 200 μm.

The lateral spacing between two tiles may be between 0.1 μm and 20 μm, in particular may be less than 5 μm, and preferably less than 1 μm.

The lateral dimension of the tiles may be between 4 μm and 150 μm, for example between 10 μm and 30 μm.

The thickness and the lateral dimension of the tiles and also the lateral spacing between two tiles may be determined in a conventional manner by scanning electron microscopy (SEM).

A tile is characterized by a thickness dimension of less than its lateral dimension (length, width, diameter).

According to the invention, the lateral dimension/thickness dimension ratio of the tiles may be between 1.2 and 200.

The layer that is in the form of a stack of non-touching tiles in accordance with the invention is also characterized by its shear strength, which must be greater than 1 Pa and less than or equal to 500 MPa.

Within the meaning of the invention, the “shear strength” of a layer is understood to denote the mechanical strength at a stress developed in the plane of the layer.

It is in contrast with a tensile strength which would, on the other hand, be the strength at a stress developed perpendicular to the plane of the stack layer.

This shear strength parameter may be determined by any conventional technique known to a person skilled in the art, and especially by the measurement defined in the standard ASTM D1002, for example by means of the eXpert 2611 machine from the manufacturer ADMET.

The layer in accordance with the invention must not be subject to a disintegration or crumbling phenomenon during simple handling of the crucible. Similarly, it must not be impaired by the stresses induced during the melting of the silicon charge, especially those induced by natural convection.

Thus, the layer in accordance with the invention has a shear strength greater than 1 Pa, for example greater than 10 kPa, especially greater than 50 kPa.

Furthermore, the layer in accordance with the invention must also have a shear strength lower than the stress induced by the difference in thermal expansion between the silicon undergoing solidification and the substrate of the crucible.

Preferably, the layer in accordance with the invention has a shear strength lower than the critical shear stress of the silicon, that is to say lower than the minimum stress that favors the appearance of dislocations of the silicon when the latter is in its plasticity domain.

Indeed, this makes it possible to facilitate notably the detachment of the silicon ingot during the cooling thereof within the crucible, and to also limit the appearance of defects, in particular of dislocations.

In particular, the layer in accordance with the invention may have a shear strength less than or equal to 300 MPa, for example less than or equal to 200 MPa, for example less than or equal to 100 MPa, for example less than or equal to 5 MPa.

The invention may be advantageously carried out on any type of conventional crucible, and for example on crucibles constituted of a dense ceramic substrate, for example made of silicon carbide SiC, silicon nitride Si₃N₄ or silica SiO₂, or of a porous substrate, for example made of graphite.

Preferably, a substrate will be chosen that is made of graphite, and especially made of isostatic, pyrolytic, vitreous, fibrous, carbon-carbon composite or flexible graphite that advantageously has a good temperature resistance.

According to one embodiment, especially when the substrate used is porous, the crucible may also comprise, at least partially on its inner surface, an intermediate insulating layer.

This intermediate insulating layer is then located between the inner surface of the crucible and the coating layer in accordance with the invention, i.e. the layer formed from a material obtained by thermal decomposition of polysilazane(s).

Such an intermediate insulating layer is intended for insulating said substrate from the coating layer.

As it emerges from what follows, this layer is generally formed, at least partially, on the inner surface of said crucible prior to the formation of the layer formed from a material obtained by thermal decomposition of polysilazane(s) in accordance with the invention.

This intermediate insulating layer affixed to the surface of the material forming said crucible could especially be a dense and continuous layer of ceramic capable of providing barrier, or even antioxidant, behavior.

Such insulating layers are well known to a person skilled in the art.

According to one embodiment, this intermediate insulating layer may be formed from at least two different materials, alternately constituting this insulating layer.

In particular, the first type of one of the materials may be formed predominantly, or even solely, from silica SiO₂, and the other material may be formed predominantly, or even solely, from silicon carbide SiC.

As indicated previously, the crucibles in accordance with the invention may be especially obtained by means of a preparation process comprising at least the formation of said layer via (a) the formation of a first stratum of tiles by (i) bringing the inner surface of said crucible into contact with a solution comprising at least one polysilazane, (ii) condensation-crosslinking of said polysilazane, (iii) pyrolysis under a controlled atmosphere and a controlled temperature and, optionally, (iv) oxidation annealing, followed by (b) the formation of at least one new stratum of tiles, contiguous to the stratum formed in step (a), by reproducing steps (i) to (iii) and, optionally, (iv), said process being characterized in that the pyrolysis of step (iii) of said process is carried out at a temperature hold realized at a temperature of at least 1000° C. for at least 1 hour.

According to one embodiment, a process in accordance with the invention may comprise a prior step of forming an intermediate insulating layer on the inner surface of said crucible.

For obvious reasons, the number of strata of tiles in the layer in accordance with the invention will depend on the number of repetitions of steps (a) and (b).

According to one embodiment, the stack in accordance with the invention may comprise from 2 to 100 strata formed of tiles, these strata being superposed and contiguous.

According to one embodiment, one of steps (a) or (b) is carried out under a reactive atmosphere, which is reactive with respect to the material deriving from the polysilazane, for example under nitrogen or in air, and the other step under an inert atmosphere, for example under argon.

This results in the formation of two different materials, for example such as defined previously.

The polysilazane solution may be deposited by any conventional technique known to a person skilled in the art, and for example may be deposited by dip coating, by spin coating, by spray coating or else using a brush.

The use of a liquid phase makes it possible to produce a deposit having a very good surface finish.

According to one embodiment, the solution comprising at least one polysilazane may also comprise a solvent, for example an aprotic anhydrous solvent, and a polymerization initiator, for example of organic peroxide type.

As aprotic anhydrous solvent, mention may especially be made of toluene, dimethylformamide, dimethyl sulfoxide and dibutyl ether.

As polymerization initiator, mention may especially be made of dicumyl peroxide, diperoxyester and peroxycarbonate.

The morphological characteristics of the tiles obtained according to the invention depend especially on the viscosity of the polysilazane solution deposited, and consequently especially on the volume concentration of polysilazane in this solution.

Preferably, the polysilazane solution used according to the invention comprises from 5 to 90% by volume, in particular from 10 to 70% by volume, for example from 10 to 50% by volume, for example from 20 to 50% by volume of polysilazane(s).

This solution may also comprise, in addition, silicon carbide powders and/or silicon nitride powders and/or silicon powders.

The addition of such powders advantageously makes it possible to adjust the viscosity of the polysilazane solution, and to thus better control the morphology of the strata of tiles of the stack in accordance with the invention.

The pyrolysis step is carried out under a controlled atmosphere, for example under an atmosphere constituted of argon, nitrogen or air, preferably argon.

An additional step of oxidation annealing in air may also be carried out.

This annealing step has a very particular advantage when the pyrolysis step is carried out under an atmosphere constituted of argon, nitrogen or aqueous ammonia. Specifically, the material obtained is then either SiC, or Si₃N₄, or a material of intermediate composition and it is may be advantageous to oxidize it in order to increase its shear strength.

This annealing step also proves advantageous for reinforcing the shear strength of a stack of layers of tiles obtained by pyrolysis carried out under an atmosphere constituted of argon and/or nitrogen.

However, it should be noted that even in the absence of an oxidation annealing step, the shear strength of such a stack of layers of tiles is already greater than 1 Pa and less than or equal to 500 MPa.

When the pyrolysis step is carried out under an atmosphere constituted of air, the annealing step has a lesser advantage since the material obtained is already oxidized at the end of the pyrolysis.

The process according to the invention makes it possible to limit, or even prevent, the contamination of the silicon ingot, and to thus obtain silicon ingots of greater purity compared to those obtained to date, while implementing conventional and inexpensive deposition techniques.

Thus, the average purity of the coatings obtained from polysilazane solutions is greater than 99.5% by weight, or even greater than 99.996% by weight, i.e. much greater than that of the coatings obtained from powders, for example from Si₃N₄ powders that have purities of the order of 98%, or 99.96%, or even less than 98%, or less than 99.96%.

The invention may be better understood on examining the appended drawing, in which:

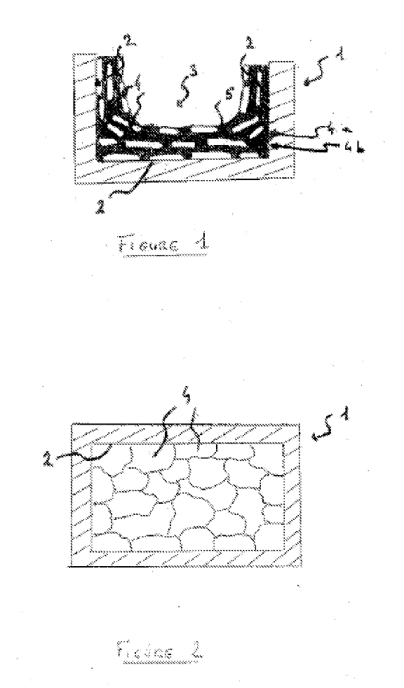

FIG. 1 schematically represents a side view of a crucible according to the invention, and

FIG. 2 schematically represents a top view of a crucible according to the invention.

As it emerges from these figures, the crucible (1) is coated on its inner surface (2) with a layer (3) formed from a material obtained by thermal decomposition of polysilazane(s).

This layer (3) is in the form of a stack of non-touching tiles (4), which gives it a cracked appearance on its upper surface represented in FIG. 2.

More precisely, this stack comprises several strata of contiguous tiles (4a) and (4b), each stratum being formed of non-touching and non-superposed tiles.

The failure of the stack occurs by shearing within the material (5) that provides the bond between the tiles (4) in the layer (3).

### EXAMPLES

The following examples are produced with various types of crucible.

During the various steps of the coating process, the crucible to be treated is immersed in the various solutions described below with the aid of a cradle and tongs.

### Example 1

The crucible used is a crucible made of graphite 2020PT™ from the company CARBONE LORRAINE having an external diameter of 50 mm, an internal diameter of 30 mm and a height of 50 mm, which is cleaned beforehand with acetone before being used and covered, during the melting of the silicon, with a cover made of silica.

The surface of the crucible to be treated according to the invention is, in addition, first coated with an insulating dense continuous layer of SiC having a thickness of around 6 μm, according to the protocol described in the publication by Bill et al. (J. of the European Ceramic Soc., vol. 16, 1996: 1115) cited above. The graphite of the crucible is thus infiltrated to a depth of around 50 μm.

A multi-strata layer according to the invention or else a stack of non-touching tiles according to the invention was formed on this crucible, according to the following protocol.

Each stratum of tiles is formed by dip coating starting from a solution containing 30% by volume of polysilazane (Ceraset PSZ20™ from the company CLARIANT) in toluene, this solution also comprising 0.1% by weight of dicumyl peroxide (Luperox DC) as polymerization initiator.

In order to do this, the crucible is immersed in this solution following three dip-coating cycles of 5 minutes, each dip-coating cycle being followed by a polymerization annealing at 200° C. for 2 h, then by a pyrolysis for two hours at 1400° C., all under nitrogen, then by an oxidation annealing in air for two hours at 1000° C.

Thus, a stack of non-touching tiles having a thickness between 180 and 200 μm is obtained, which is constituted of strata of tiles of variable thickness, between 13 and 28 μm.

The crucible according to the invention thus formed is tested as follows:

70 g of solid silicon are then placed, manually and very carefully, in the resulting crucible, and are then melted according to the following cycle: temperature increase at a rate of 200° C. per hour up to 1000° C. under low vacuum, followed by a hold for a duration of one hour with introduction of a static argon atmosphere, then temperature increase at a rate of 150° C. per hour up to 1500° C. and maintenance at this temperature for 4 hours, and finally decrease at a rate of 50° C. per hour down to 1200° C., then maintenance at this temperature for 1 hour.

The cooling then takes place freely down to ambient temperature.

After cooling, the silicon ingot thus formed detaches from the crucible in accordance with the invention by cohesive failure within the coating.

The purity of the coating used in the crucible will be found again in the silicon ingot. Silicon that is more than 99.6% pure, or even more than 99.996% pure, is obtained.

The purity was assessed by GDMS (Glow Discharge Mass Spectrometry) technology.

### Example 2

The crucible used is identical to the crucible described in example 1.

However, the surface of the crucible to be treated according to the invention is first coated with an insulating dense continuous layer of SiC having a thickness of around 45 μm, covered with an insulating layer of SiO₂ of around 4 μm, obtained by reactive infiltration according to the protocol described in the publication by Israel et al. (J. of the European Ceramic Soc., vol 31, (2011), 2167-2174).

A stack of non-touching tiles according to the invention was formed on the surface of the intermediate layer of SiO₂ according to the protocol described in example 1.

The crucible according to the invention thus formed, and tested according to the protocol described in example 1, proves capable of forming silicon ingots having a purity of greater than 99.996%.

### Example 3

The crucible used is a crucible made of vitreous silica manufactured by the company MondiaQuartz having an external diameter of 50 mm, an internal diameter of 30 mm and a height of 50 mm; it is cleaned beforehand with acetone before being used.

A stack of non-touching tiles according to the invention was formed according to the protocol described in example 1.

The crucible according to the invention thus formed, and tested according to the protocol described in example 1, also proves suitable for forming very pure silicon ingots.

### Example 4

The crucible used is a crucible made of graphite 2020PT™ from the company CARBONE LORRAINE having an external diameter of 50 mm, an internal diameter of 30 mm and a height of 50 mm; it is cleaned beforehand with acetone, then degassed under low vacuum at 50° C. for 30 minutes before being used.

Its surface is first coated with an insulating dense continuous layer of SiC having a thickness of around 14 μm, according to the protocol described in the publication by Bill et al. (J. of the European Ceramic Soc., vol. 16, 1996: 1115) cited above. The graphite of the crucible is thus infiltrated to a depth of around 450 μm.

A stack of thin strata according to the invention was formed on this crucible, according to the following protocol.

The layer according to the invention is formed starting from a solution containing 30% by volume of polysilazane (Ceraset PSZ20™ from the company CLARIANT) in toluene, this solution also comprising 0.1% by weight of dicumyl peroxide (Luperox DC) as polymerization initiator.

More specifically, the crucible is immersed, with the aid of a cradle and tongs, in this solution and then it is removed from the bath slowly, and the excess liquid is drained off by gravity. The dip coating is followed by a step of polymerization under argon for one hour at 150° C. and then by a pyrolysis under argon for two hours at 1000° C.

This sequence of steps, dip coating/polymerization/pyrolysis under argon, is repeated eight times, then the crucible thus coated undergoes an oxidation annealing in air for two hours at 1000° C.

Thus, a layer having a thickness between 60 and 95 μm is obtained, which is constituted of a stack of strata, each stratum being formed of tiles of variable thickness, between 3 and 12 μm.

The crucible according to the invention thus formed is tested as follows:

70 g of electronic quality silicon are then deposited, manually and very carefully, in the resulting crucible. The silicon is then melted according to the following cycle: temperature increase at a rate of 200° C. per hour up to 1000° C. under low vacuum, followed by a hold for a duration of one hour with introduction of a static argon atmosphere, then temperature increase at a rate of 150° C. per hour up to 1500° C. and maintenance at this temperature for 4 hours, and finally decrease at a rate of 50° C. per hour down to 1200° C.

The cooling then takes place freely down to ambient temperature.

After cooling, the silicon ingot thus formed detaches from the crucible in accordance with the invention, after a few impacts on its circumference, predominantly by cohesive failure within the coating.

### Example 5

The crucible used is a crucible made of vitreous silica manufactured by the company MondiaQuartz having an external diameter of 50 mm, an internal diameter of 45 mm and a height of 50 mm; it is cleaned beforehand with acetone before being used.

A stack of thin layers according to the invention was formed on this crucible, starting from a solution containing 50% by volume of polysilazane (Ceraset PSZ20™ from the company CLARIANT) in anhydrous dibutyl ether (Sigma Aldrich).

More specifically, the crucible is immersed, with the aid of a cradle and tongs, in this solution and then it is removed from the bath slowly, and the excess liquid is drained off by gravity. The dip coating is followed by a step of polymerization under argon for two hours at 200° C. and then by a pyrolysis under argon for two hours at 1000° C.

This sequence of steps, dip coating/polymerization/pyrolysis under argon, is repeated twelve times, then the crucible thus coated undergoes an oxidation annealing in air for two hours at 1000° C.

Thus, a layer having a thickness between 65 and 110 μm is obtained, which is constituted of a stack of strata, each stratum being formed of tiles of variable thickness, between 1 and 10 μm.

The crucible according to the invention thus formed is tested as follows:

72 g of electronic quality silicon are then deposited, manually and very carefully, in the resulting crucible. The silicon is then melted according to the following cycle: temperature increase at a rate of 200° C. per hour up to 1000° C. under low vacuum, followed by a hold for a duration of one hour with introduction of a static argon atmosphere, then temperature increase at a rate of 150° C. per hour up to 1500° C. and maintenance at this temperature for 4 hours, and finally decrease at a rate of 50° C. per hour down to 1200° C.

The cooling then takes place freely down to ambient temperature.

After cooling, the silicon ingot thus formed detaches from the crucible in accordance with the invention, after a few impacts on its circumference, predominantly by cohesive failure within the coating.

### Example 6

The crucible used is a crucible made of graphite R6510™ manufactured by the company SGL-Carbon having an external diameter of 50 mm, an internal diameter of 40 mm and a height of 50 mm.

Its surface is coated with an insulating dense continuous layer of SiC having a thickness of around 70 μm, obtained by chemical vapor reaction (CVD). The layer of SiC is first oxidized by annealing at 1200° C. in air for 5 h.

A stack of thin layers according to the invention was formed on this crucible, starting from a solution containing 50% by volume of polysilazane (Ceraset PSZ20™ from the company CLARIANT) in anhydrous dibutyl ether (Sigma Aldrich).

More specifically, the crucible is immersed, with the aid of a cradle and tongs, in this solution and then it is removed from the bath slowly, and the excess liquid is drained off by gravity. The dip coating is followed by a step of polymerization in air for two hours at 200° C. and then by a pyrolysis in air for two hours at 1000° C.

This sequence of steps, dip coating/polymerization/pyrolysis in air, is repeated ten times.

Thus, a layer having a thickness between 60 and 90 μm is obtained, which is constituted of a stack of strata, each stratum being formed of tiles of variable thickness, between 1 and 10 μm.

The crucible according to the invention thus formed is tested as follows:

72 g of electronic quality silicon are then deposited, manually and very carefully, in the resulting crucible. The silicon is then melted according to the following cycle: temperature increase at a rate of 200° C. per hour up to 1000° C. under low vacuum, followed by a hold for a duration of one hour with introduction of a static argon atmosphere, then temperature increase at a rate of 150° C. per hour up to 1500° C. and maintenance at this temperature for 4 hours, and finally decrease at a rate of 50° C. per hour down to 1200° C.

The cooling then takes place freely down to ambient temperature.

After cooling, the silicon ingot thus formed detaches from the crucible in accordance with the invention, after a few impacts on its circumference, predominantly by cohesive failure within the coating.

### Example 7

The crucible used is a crucible made of vitreous silica manufactured by the company MondiaQuartz having an external diameter of 50 mm, an internal diameter of 45 mm and a height of 50 mm; it is cleaned beforehand with acetone before being used.

A stack of thin layers according to the invention was formed on this crucible, starting from a solution containing 80% by volume of polysilazane (Ceraset PSZ20™ from the company CLARIANT) in anhydrous dibutyl ether (Sigma Aldrich).

In the case of this embodiment, the polysilazane solutions are applied to the crucible by spraying by spray coating. The spray coating is followed by a step of polymerization in air for thirty minutes at 500° C. on a hot plate.

This spray coating/polymerization at 500° C. sequence is repeated six times, then the crucible thus coated undergoes a step of pyrolysis at 1000° C. for one hour under nitrogen.

This sequence of steps is repeated four times.

The crucible according to the invention thus formed is tested as follows:

72 g of electronic quality silicon are then deposited, manually and very carefully, in the resulting crucible. The silicon is then melted according to the following cycle: temperature increase at a rate of 200° C. per hour up to 1000° C. under low vacuum, followed by a hold for a duration of one hour with introduction of a static argon atmosphere, then temperature increase at a rate of 150° C. per hour up to 1500° C. and maintenance at this temperature for 4 hours, and finally decrease at a rate of 50° C. per hour down to 1200° C.

The cooling then takes place freely down to ambient temperature.

After cooling, the silicon ingot thus formed detaches from the crucible in accordance with the invention, after a few impacts on its circumference, predominantly by cohesive failure within the coating.

### Example 8

### Comparison of a Treated Crucible According to the Invention with a Standard Crucible

The crucibles used are crucibles made of vitreous silica manufactured by the company MondiaQuartz having an external diameter of 145 mm, an internal diameter of 140 mm and a height of 150 mm; they are cleaned beforehand with acetone and ethanol before being used.

The inner surface of the control crucible is coated over its entirety with a standard non-stick coating made of silicon nitride powder (SNE10, UBE) in suspension in a mixture of water and PVA. This suspension is applied by spraying as 4 successive layers on the inner surface of the crucible, with air drying for 5 minutes between each layer, then it is oxidized at 900° C. for 2 h in air in position on its substrate. This sequence of steps, spraying as 4 layers/drying/oxidation, is repeated twice.

The vertical walls of the crucible according to the invention are coated on its inner surface with the same coating as above.

On the other hand, the inner surface forming the bottom of the crucible according to the invention is coated with a stack of thin layers in accordance with the invention, formed from a solution containing 50% by volume of polysilazane (Ceraset PSZ20™ from the company CLARIANT) in anhydrous dibutyl ether (Sigma Aldrich).

More specifically, 1 ml of solution is deposited in the bottom of the crucible. The crucible is then rotated on a turntable until the layer has spread completely, and the excess liquid is drained off by gravity (runoff along the bare vertical walls). The spin coating is followed by a step of polymerization in air for two hours at 200° C., then by a pyrolysis in air for two hours at 1000° C.

This sequence of steps, deposition/rotation/polymerization/pyrolysis, is repeated thirty times, then the bottom of the crucible thus coated undergoes an oxidation annealing by exposing the crucible in air for two hours at 1000° C.

Thus obtained at the bottom of the crucible is a layer having a thickness between 50 and 120 μm, which is constituted of a stack of strata, each stratum being formed of tiles of variable thickness, between 1 and 10 μm.

The crucibles thus formed are tested as follows:

2.3 kg of electronic quality silicon are then deposited, manually and very carefully, in each of the resulting crucibles. The silicon is then melted according to the following cycle: temperature increase at a rate of 200° C. per hour up to 1000° C. under low vacuum, followed by the introduction of an argon atmosphere circulating at a flow rate of 0.5 l/min, then temperature increase at a rate of 150° C. per hour up to 1550° C. and maintenance at this temperature for 5 hours, and finally decrease at a rate of 50° C. per hour down to 1200° C. The cooling then takes place at a rate of 200° C. per hour down to ambient temperature.

After cooling, the silicon ingot formed in the control crucible detaches from the crucible spontaneously. The ingot formed in the crucible according to the invention, i.e. the bottom of which is in accordance with the invention, detaches after a few impacts on its circumference, predominantly by cohesive failure within the coating.

The ingots thus obtained are cut into vertical wafers having a thickness of 20 mm, and lifetime analyses of the minority carriers in these wafers are carried out.

The principle of this measurement is the following: a pulsed laser excitation of the surface (to a depth of 1 mm) makes it possible to generate electron-hole pairs in the semiconductor material that will recombine after a characteristic time (lifetime) which is highly dependent on the amount of impurities present, resulting from the materials of the crucible. The mapping of the lifetimes in the wafers of the ingots is carried out by a measurement of the decrease of photoconductivity, induced by the generation of these charge carriers, and it is carried out on a WT200 machine from Semilab.

These analyses prove that the silicon in contact with the zones of the crucible in accordance with the invention (bottom of the ingot referred to as according to the invention) has lifetimes, and therefore a purity, that are much better than the silicon in contact of the coating referred to as standard (bottom of the ingot referred to as control). The thickness of the polluted zone is estimated at around 6 mm in the ingot referred to as the control whereas it is between 2 and 3 mm in the ingot referred to as according to the invention.

1.-22. (canceled)

23. A crucible useful for solidifying a silicon ingot from molten silicon coated at least partially on an inner surface with at least one layer formed from a material obtained by thermal decomposition of polysilazane(s), the layer having a shear strength greater than 1 Pa and less than or equal to 500 MPa and comprised of a stack of contiguous strata of non-touching tiles.

24. The crucible of claim 23, wherein each of the strata of tiles forming the stack is between 0.2 and 50 μm thick.

25. The crucible of claim 23, wherein the stack is between 10 and 500 μm thick.

26. The crucible of claim 23, wherein the stack comprises from 2 to 100 strata of tiles and the strata are superposed and contiguous.

27. The crucible of claim 23, wherein the layer has a shear strength less than or equal to 300 MPa.

28. The crucible of claim 23, wherein the layer comprises silicon carbide SiC, silicon nitride Si₃N₄ and/or silicon oxycarbonitride.

29. The crucible of claim 23, wherein the tiles are made of silicon carbide SiC, silicon nitride Si₃N₄, a mixture of SiC and Si₃N₄, or silicon oxycarbonitride SiCNO.

30. The crucible of claim 23, wherein the tiles forming all of the strata constituting the layer are made of the same material.

31. The crucible of claim 23, wherein the tiles forming all of the strata constituting the layer are made of two different materials.

32. The crucible of claim 23, wherein the tiles are spaced laterally by 0.1 μm to 20 m.

33. The crucible of claim 23, further comprising at least partially on the inner surface, an intermediate insulating layer located between the inner surface and the layer formed from a material obtained by thermal decomposition of polysilazane(s).

34. The crucible of claim 33, wherein the intermediate insulating layer is formed from at least two alternating materials.

35. The crucible of claim 34, wherein the insulating layer comprises a first material formed predominantly or solely of silica SiO₂, and a second material is formed predominantly or solely of silicon carbide SiC.

36. The crucible of claim 23, further defined as comprising a dense ceramic substrate or a porous substrate.

37. The crucible of claim 36, wherein the substrate comprises silicon carbide SiC, silicon nitride Si₃N₄, silica SiO₂, or graphite.

38. A process for preparing a crucible of claim 23, comprising at least the formation of a layer via:
(a) forming of a first stratum of tiles by a method comprising:
(i) bringing the inner surface of the crucible into contact with a solution comprising at least one polysilazane;
(ii) crosslinking the polysilazane with a condensation-crosslinking process; and
(iii) pyrolyzing under a controlled atmosphere and a controlled temperature and comprising a temperature hold at a temperature of at least 1000° C. for at least 1 hour; and
(b) forming at least one additional stratum of tiles, contiguous to the stratum formed in step (a), by reproducing steps (i) to (iii).

39. The process of claim 38, wherein formation of the first stratum of tiles further comprises annealing the layer with an oxidation annealing process.

40. The process of claim 38, wherein one of steps (a) or (b) is carried out under a reactive atmosphere, which is reactive with respect to the material derived from the polysilazane and the other step under an inert atmosphere.

41. The process of claim 38, further defined as comprising a step of forming an intermediate insulating layer on the inner surface of the crucible.

42. The process of claim 38, wherein the solution comprising at least one polysilazane also comprises a solvent and a polymerization initiator.

43. The process of claim 42, wherein the solvent is an aprotic anhydrous solvent further defined as comprising toluene, dimethylformamide, dimethyl sulfoxide, or dibutyl ether.

44. The process of claim 42, wherein the polymerization initiator is of organic peroxide type.

45. The process of claim 38, wherein the solution comprising at least one polysilazane also comprises silicon carbide powders and/or silicon nitride powders and/or silicon powders.

46. The process of claim 38, wherein the solution comprises from 5 to 90% by volume of polysilazane(s).

47. A method comprising:
obtaining a crucible of claim 23; and
using the crucible in a process for directional solidification of silicon.
